(19) United States
(12) Patent Application Publication
(10) Pub. No.: US 2005/0264687 A1
(43) Pub. Date: Dec. 1, 2005

(54) Endoscope

(75) Inventor: Jin Murayama, Kurokawa-gun (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Fuji Photo Film Co., Ltd., Minami-Ashigara-shi (JP)

(21) Appl. No.: 11/136,361

(22) Filed: May 25, 2005

(30) Foreign Application Priority Data
May 26, 2004 (JP) 2004-156509

(51) Int. Cl. H04N 5/335

(52) U.S. Cl. 348/370

(57) ABSTRACT

An endoscope including: a light source for emitting light; a solid state imaging unit comprising a plurality of photoelectric conversion elements for accumulating signal charges corresponding to an incidence light amount, transfer units for transferring signal charges accumulated in the photoelectric conversion elements, and a plurality of color filters formed above the photoelectric conversion elements; and a transmission tube accommodating the light source and the solid state imaging unit, wherein the color filters include red, green and blue color filters, and the number of red photoelectric conversion elements upon which light transmitted through the red color filters are incident is larger than the number of green photoelectric conversion elements upon which light transmitted through the green color filters are incident and the number of blue photoelectric conversion elements upon which light transmitted through the blue color filters are incident. The endoscope can obtain a high quality image.

### CROSS REFERENCE TO RELATED APPLICATION

This application is based on and claims priority of Japanese Patent Application No. 2004-156509 filed on May 26, 2004, the entire contents of which are incorporated herein by reference.

### BACKGROUND OF THE INVENTION

A) Field of the Invention

The present invention relates to an endoscope for color imaging.

B) Description of the Related Art

FIG. 3A is a block diagram showing a main portion of a solid image pickup device assembling a solid state imaging unit, and FIGS. 3B and 3C are schematic plan views showing the structure of a solid state imaging unit. FIG. 3D is a cross sectional view showing a portion of a pixel arrangement unit of a solid state imaging unit. FIGS. 3E and 3F are schematic plan views showing layouts of a color filter layer of three primary colors, red (R), green (G) and blue (B). FIG. 3G is a flow chart briefly illustrating image data processing.

Referring to FIG. 3A, the structure of a solid state image pickup device will be described. A solid state imaging unit 51 generates signal charges corresponding to an amount of light incident upon each pixel and supplies an image signal corresponding to the generated signal charges. A drive signal generator 52 generates drive signals (transfer voltage, etc.) for driving the solid state imaging unit 51 and supplies them to the solid state imaging unit 51. An analog front end (AFE) 53 adjusts a gain in accordance with a change in the level of an input signal supplied from the solid state imaging unit 51, to maintain constant the level of an output signal. A digital signal processor (DSP) 54 processes an image signal supplied from the analog front end 53, such as recognition process, data compression and network control, and outputs the processed image data. A timing generator (TG) 55 generates timing signals for the solid state imaging unit 51, drive signal generator 52 and analog front end 53, to control the operations thereof.

Solid state imaging units are mainly divided into CCD types and MOS types. In the CCD type, charges generated in a pixel is transferred by charge coupled devices (CCD). In the MOS type, charges generated in a pixel are amplified by a MOS transistor and output. Although not limitative, the following description will be made by using a CCD type as an example.

The drive signal generator 52 includes, for example, a V driver for generating a vertical CCD drive signal. Signals supplied from the drive signal generator 52 to the solid state imaging unit 51 are a horizontal CCD drive signal, a vertical CCD drive signal, an output amplifier drive signal and a substrate bias signal.

As shown in FIG. 3B, the solid state imaging unit is constituted of: a plurality of photosensitive units 62 disposed, for example, in a matrix shape; a plurality of vertical CCD units 64, a horizontal CCD unit 66 electrically connected to the vertical CCD units 64; and an amplifier circuit unit 67, connected to an output terminal of the horizontal CCD unit 66, for amplifying an output charge signal from the horizontal CCD unit 66. A pixel arrangement unit 61 is constituted of the photosensitive units 62 and vertical CCD units 64.

The photosensitive unit 62 is constituted of a photosensitive element, e.g., a photoelectric conversion element (photodiode) and a read out gate. The photoelectric conversion element generates signal charges corresponding to an incidence light amount and accumulates them. The accumulated signal charges are read via the read out gate to the vertical CCD unit 64 and transferred in the vertical CCD unit (vertical transfer channel) 64 toward the horizontal CCD unit 66 (in a vertical direction). Signal charges transferred to the bottom end of the vertical CCD unit 64 are transferred in the horizontal CCD unit (horizontal transfer channel) 66 in a horizontal direction, amplified by the amplifier circuit unit 67 and output to an external.

The photosensitive units 62 are disposed in a square matrix layout at a constant pitch in the row and column directions as shown in FIG. 3B, or disposed in a honeycomb layout in the row and column directions by shifting every second units, for example, by a half pitch.

FIG. 3C is a schematic plan view of a solid state imaging unit having the pixel interleaved layout. The pixel interleaved layout has photosensitive units 62 disposed in a first square matrix layout and photosensitive units 62 disposed in a second square matrix layout at positions between lattice points of the first square matrix layout. Vertical CCD units (vertical transfer channels) 64 are disposed in a zigzag way between photosensitive units 62. Although this layout is called a pixel interleaved layout, the photosensitive unit 62 of most pixel interleaved layouts is octangular.

As shown in FIG. 3D, formed in a p-type well 82 formed in a semiconductor substrate 81, e.g., an n-type silicon substrate, are a photoelectric conversion element 71 made of an n-type impurity doped region, a p-type read gate 72 disposed next to the photoelectric conversion element, and a vertical transfer channel 73 of made of an n-type region disposed next to the read out gate. A vertical transfer electrode 75 is formed above the vertical transfer channel 73, with a gate insulating film 74 being interposed therebetween. A p-type channel stop region 76 is formed between adjacent photoelectric conversion elements 71.

The channel stop region 76 is used for electrically isolating the photoelectric conversion elements 71, vertical transfer channels 73 and the like. The gate insulating film 74 is a silicon oxide film formed on the surface of the semiconductor substrate 81, for example, by thermal oxidation. The vertical transfer electrode 75 is constituted of first and second vertical transfer electrodes made of, for example, polysilicon. The first and second vertical transfer electrodes may be made of amorphous silicon. An insulating silicon oxide film 77 is formed on the vertical transfer electrode 75, for example, by thermally oxidizing polysilicon. The vertical CCD unit 64 is constituted of the vertical transfer channel 73, upper gate insulating film 74 and vertical transfer electrode 75.

A light shielding film 79 of, e.g., tungsten, is formed above the vertical transfer electrode 75, with the insulating silicon oxide film 77 being interposed therebetween. Openings 79a are formed through the light shielding film 79 at positions above the photoelectric conversion elements 71. A silicon nitride film 78 is formed on the light shielding film 79.

Signal charges corresponding to an incidence light amount generated in the photoelectric conversion element 71 are read via the read out gate 72 into the vertical transfer channel 73 and transferred in the vertical transfer channel 73 in response to a drive signal (transfer voltage) applied to the vertical transfer electrodes 75. As described above, the light shielding film 79 has the openings 79a above the photoelectric conversion elements 71 and prevents light incident upon the pixel arrangement unit 61 from entering the region other than the photoelectric conversion elements 71.

A planarized layer 83a made of, e.g., borophosphosilicate glass (BPSG) is formed above the light shielding film 79. On this planarized surface, a color filter layer 84 is formed which is three primary colors: red (R), green (G) and blue (B). Another planarized layer 83b is formed on the color filter layer 84. On the planarized layer 83 having a planarized surface, micro lenses 85 are formed, for example, by melting and solidifying a photoresist pattern of micro lenses. Each micro lens 85 is a fine hemispherical convex lens disposed above each photoelectric conversion element 71. The micro lens 85 converges incidence light to the photoelectric conversion elements 71. Light converged by one micro lens 85 passes through the color filter layer 84 of one of the red (R), green (G) and blue (B) and becomes incident upon one photoelectric conversion element 71. Therefore, the photoelectric conversion elements include three types of photoelectric conversion elements: photoelectric conversion elements upon which light passed through the red (R) color filter layer 84 becomes incident; photoelectric conversion elements upon which light passed through the green (G) color filter layer 84 becomes incident; and photoelectric conversion elements upon which light passed through the blue (B) color filter layer 84 becomes incident.

In the specification and claims, “above” the photoelectric conversion element or the semiconductor substrate on which the photoelectric conversion elements are formed, intended to mean “at a higher position” in the above-described structure of the solid state imaging unit.

FIG. 3E shows an example of the layout of color filters of three primary colors, red (R), green (G) and blue (B) of a solid state imaging unit having photoelectric conversion elements 71 disposed in the square matrix shape. Green (G) filters are disposed in a checkered pattern, and a row having green (G) filters and red (R) filters disposed alternately and a row having green (G) filters and blue (B) filters disposed alternately are alternately disposed along the column direction, to form the color filter layer of three primary colors (Bayer layout). In this layout, the pixel number ratio of red (R), green (G) and blue (B) pixels is 1:2:1.

FIG. 3F shows an example of the layout of the color filters of three primary colors, red (R), green (G) and blue (B) of a solid state imaging unit having photoelectric conversion elements 71 disposed in the honeycomb layout.

Red (R) and blue (B) filters are disposed in a checkered pattern above the photosensitive units disposed in a first square matrix shape, and green (G) filters are disposed above the photosensitive units disposed in a second square matrix shape at positions between lattice points of the first square matrix shape (pixel interleaved array (PIA)). Also in this layout, the pixel number ratio of red (R), green (G) and blue (B) pixels is 1:2:1.

In the layouts of three primary colors shown in FIGS. 3E and 3F, the number of pixels, upon which light passed through the green (G) color filters becomes incident, is largest (for example, refer to Japanese Patent Laid-open Publication No. HEI-10-262260).

Most of image pickup elements for general photographing, such as video cameras, digital still image cameras and cameras of portable phones, have the pixel number ratio of red (R), green (G) and blue (B) of 1:2:1. This is because green components of general images contribute more to the resolution of human eyes.

With reference to FIG. 3G, brief description will be made on an example of image data processing by the digital signal processor (DSP) 54.

Digital data output from the analog front end (AFE) 53 is supplied to the digital signal processor (DSP) 54. The supplied data is first subjected to interpolation calculation which calculates full resolution image data of each of red (R), green (G) and blue (B). Data after the interpolation calculation is thereafter subjected to a gamma process, a spatial filtering process and a tone adjustment process to thereby output image data.

With the interpolation calculation, data of each of red (R), green (G) and blue (B) is formed for the pixel layout of the square matrix shape shown in FIG. 3E, and data of each of red (R), green (G) and blue (B) at each pixel position and at a middle position between adjacent pixels is formed for the pixel layout of the honeycomb shape shown in FIG. 3F.

If a medical endoscope using a solid state imaging unit with a pixel number ratio of red (R), green (G) and blue (B) of 1:2:1 is used for photographing organs or tissues in a human body, it is difficult to obtain an image of high resolution and good color reproduction. This is because there are large red (R) color components in a body.

### SUMMARY OF THE INVENTION

An object of this invention is to provide an endoscope capable of obtaining a high quality image.

According to one aspect of the present invention, there is provided an endoscope comprising: a light source for emitting light; a solid state imaging unit comprising a plurality of photoelectric conversion elements for accumulating signal charges corresponding to an incidence light amount, transfer units for transferring signal charges accumulated in the photoelectric conversion elements, and a plurality of color filters formed above the photoelectric conversion elements; and a transmission tube accommodating the light source and the solid state imaging unit, wherein the color filters include red, green and blue color filters, and the number of red photoelectric conversion elements upon which light transmitted through the red color filters are incident is larger than the number of green photoelectric conversion elements upon which light transmitted through the green color filters are incident and the number of blue photoelectric conversion elements upon which light transmitted through the blue color filters are incident.

This endoscope has an excellent resolution of red color components and is suitable for photographing a good quality image of the interior of a living body having large red color components.

According to the present invention, it is possible to provide an endoscope capable of obtaining a high quality image.

### BRIEF DESCRIPTION OF THE DRAWINGS

FIG. 1A is a schematic plan view showing the outline of a tip portion of an optical magnification electronic scope (endoscope) for observing precisely an upper digestive tract, FIG. 1B is a perspective view showing the tip portion of the scope and a tube connected to the tip portion, and FIGS. 1C and 1D are schematic diagrams showing an observation optical system of the scope.

FIGS. 2A and 2B are schematic plan views showing the layouts of color filters of three primary colors of red (R), green (G) and blue (B) of a solid state imaging unit used by an optical magnification electronic scope for observing precisely an upper digestive tract.

FIG. 3A is a block diagram showing a main portion of a solid image pickup device assembling a solid state imaging unit, FIGS. 3B and 3C are schematic plan views showing the structure of a solid state imaging unit, FIG. 3D is a cross sectional view showing a portion of a pixel arrangement unit of a solid state imaging unit, FIGS. 3E and 3F are schematic plan views showing layouts of a color filter layer of three primary colors, red (R), green (G) and blue (B), and FIG. 3G is a flow chart briefly illustrating image data processing.

### DESCRIPTION OF THE PREFERRED EMBODIMENTS

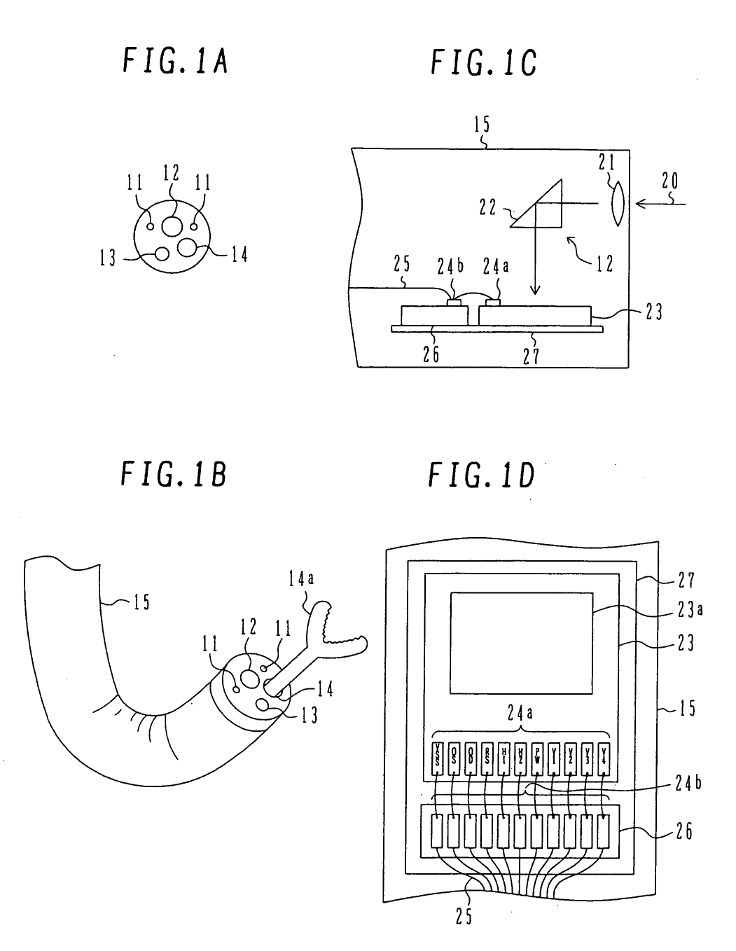

FIG. 1A is a schematic plan view showing the outline of a tip portion of an optical magnification electronic scope for observing precisely an upper digestive tract, FIG. 1B is a perspective view showing the tip portion of the scope and a tube connected to the tip portion, and FIGS. 1C and 1D are schematic diagrams showing an observation optical system of the scope.

Referring to FIG. 1A, the tip portion of an optical magnification electronic scope for observing precisely an upper digestive tract, is of generally the circular shape having a diameter of, e.g., 10.8 mm. This tip portion is constituted of a light source 11 with two light output openings, an observation optical system 12, a nozzle 13 and a forceps opening 14. The light source 11 includes a light emission source, a light guide (fiber) and light output openings. The electronic scope is used, for example, as a photogastroscope.

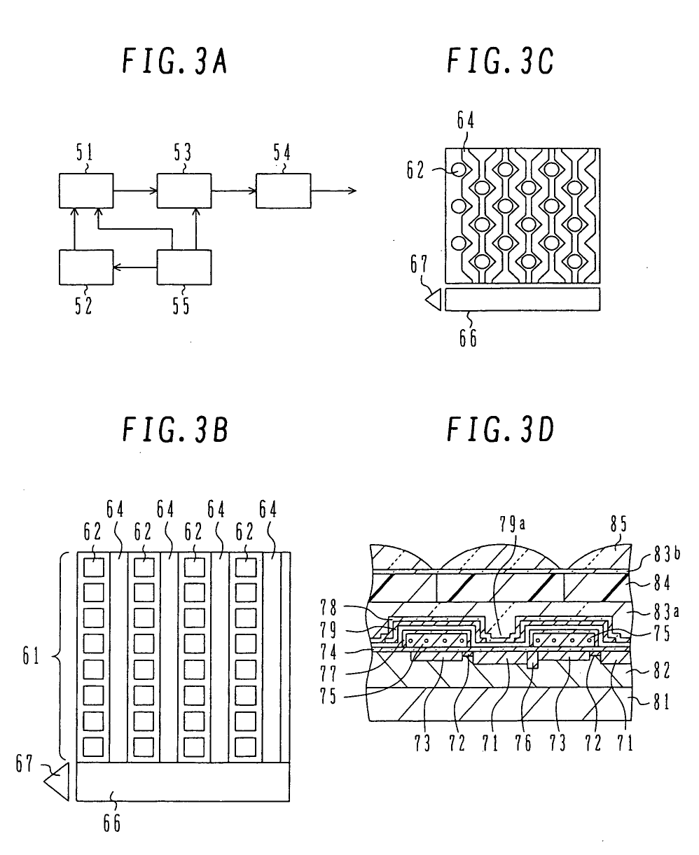

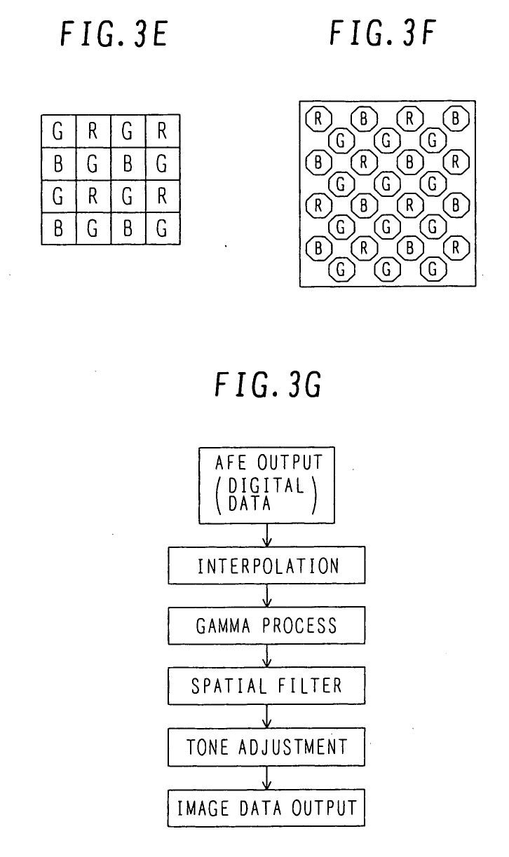

The light source 11 emits white light with light in the infrared range being cut, through the two light output openings and illuminates, e.g., the inner wall of a human gaster. The observation optical system 12 includes a solid state imaging unit similar to the solid state imaging unit described with reference to FIGS. 3B to 3D (with a difference between the layouts of color filters, as will be later described). The observation optical system 12 receives mainly light emitted from the light source 11 and reflected from the inner wall of the gaster, and forms an image which is sent to an observer. The observation optical system 12 will be later described in detail. The nozzle 13 jets out gas or liquid such as washing liquid and dye liquid for facilitating observation of a diseased part. A pair of forceps protrudes through the forceps opening 14 which has a diameter of, e.g., 2.8 mm.

Referring to FIG. 1B, the pair of forceps 14a is moved in and out through the forceps opening 14. The pair of forceps 14a has a tip portion which can perform an open/close operation like blades of a pair of scissors, and can hold a target member. By operating the pair of forceps 14a, it becomes possible to observe minutely a diseased part, pick up cells of the diseased part or cut the diseased part.

The light source 11, observation optical system 12, nozzle 13 and forceps 14a are accommodated in a tube 15, e.g., near the end portion thereof. For example, the tube 15 is guided into the interior of a body from a mouth to make the end portion reach a position near a diseased part. The tube 15 near the end portion is made flexible so that the observation optical system 12 and the like can be positioned nearer to the diseased part and the operability of the scope can be improved. A full length of the tube 15 is, e.g., 1400 mm. A manipulation apparatus is coupled to the end of the tube 15 opposite to the side where the observation optical system 12 and the like are disposed. The manipulation apparatus can operate the light source 11, observation optical system 12, nozzle 13 and forceps 14a. Image data from the observation optical system 12 is transmitted via the inside of the tube 15. The tube 15 is a mechanical and electrical transmission tube.

With reference to FIG. 1C, description will be made on the observation optical system 12. The observation optical system 12 is constituted of an objective lens 21, a prism 22, a semiconductor chip 23 and a wiring board 26. Light 20 emitted from the light source 11 and reflected from, e.g., the inner wall of a gaster, becomes incident upon the objective lens 21, is bent generally a right angle by the prism 22, and becomes incident upon the semiconductor chip 23. The semiconductor chip 23 has a solid state imaging unit such as that described with reference to FIGS. 3B to 3D, and pads 24a. These pads 24a of the semiconductor chip 23 are wire-bonded to pads 24b of the wiring board 26 on which a driver circuit and the like and wirings are formed. Lead wires 25 are connected to the pads 24b on the wiring board 26. The lead wires 25 extend in the tube 15 along its extension direction. The semiconductor chip 23 and wiring board 26 are supported on a support plate 27.

Referring to FIG. 1D, light 20 becomes incident upon the objective lens 21, changes its propagation direction at the prism 22 and becomes incident upon the photoelectric conversion elements in the light reception unit 23a of the solid state imaging unit in the semiconductor chip 23. As described earlier, one of color filters of three primary colors is disposed above each photoelectric conversion element. The light 20 transmits through one of color filters of red (R), green (G) and blue (B) and becomes incident upon the photoelectric conversion element which generates and accumulates signal charges. The signal charges are transferred in the solid state imaging unit, processed in the manner described with reference to FIGS. 3A and 3G, and output as image data. The image data is sent to an external via the lead wires 25.

The semiconductor chip 23 is disposed in such a manner that its principal surface (on which photoelectric conversion elements are formed) of, e.g., a rectangular shape is set vertical to the cross section of the tube 15 and a longitudinal direction of the principal surface is set parallel to the extension direction of the tube 15. With this arrangement, the scope can be made compact. In order to set the principal surface of the semiconductor chip 23 vertical to the cross section of the tube 15, the propagation direction of incidence light is changed by the prism 22.

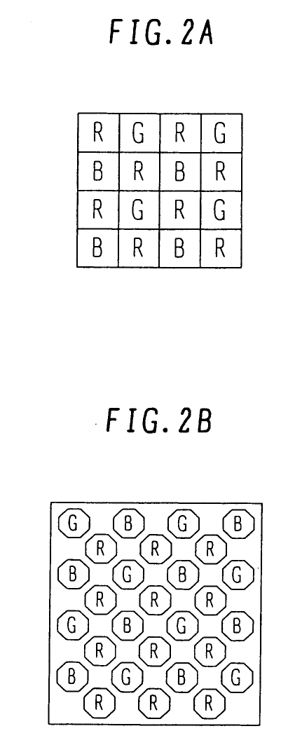

FIGS. 2A and 2B are schematic plan views showing the layouts of color filters of three primary colors of red (R), green (G) and blue (B) of a solid state imaging unit used by an optical magnification electronic scope for observing precisely an upper digestive tract. FIG. 2A shows an example of the layout of a solid state imaging unit whose photoelectric conversion elements are disposed in the square matrix shape, and FIG. 2B shows an example of the layout of a solid state imaging unit whose photoelectric conversion elements are disposed in the honeycomb shape. FIG. 2A corresponds to FIG. 3E, and FIG. 2B corresponds to FIG. 3F.

In the layout of color filters of three primary colors shown in FIG. 2A, red (R) filters are disposed in a checkered pattern, and a row having red (R) filters and green (G) filters disposed alternately and a row having red (R) filters and blue (B) filters disposed alternately are alternately disposed along the column direction, to form the color filter layer of three primary colors. As compared to the layout shown in FIG. 3E, the red (R) filter and the green (G) filter are exchanged. In the layout shown in FIG. 2A, the pixel number ratio of red (R), green(G) and blue (B) is 2:1:1.

In the layout of color filters of three primary colors shown in FIG. 2B, green (G) and blue (B) filters are disposed in a checkered pattern above the photosensitive unit disposed in a first square matrix shape, and red (R) filters are disposed above the photosensitive units disposed in a second square matrix shape at positions between lattice points of the first square matrix shape. As compared to the layout shown in FIG. 3F, the red (R) filter and the green (G) filter are exchanged. In the layout shown in FIG. 2B, the pixel number ratio of red (R), green(G) and blue (B) is 2:1:1.

By using the color filters having the layout shown in FIG. 2A or 2B, the resolution of red (R) color components can be increased so that a good quality image of the interior of a living body (such as a fine blood vessel) can be photographed. This contributes to high quality medical care.

With the color filters having the layout shown in FIG. 2A or 2B, the image signal processing described with reference to FIG. 3G is executed by considering the pixel number ratio of red (R), green (G) and blue (B) of 2:1:1. In the interpolation calculation process shown in FIG. 3G, R interpolation is performed by a method similar to conventional G interpolation, and G interpolation is performed by a method similar to conventional R/B interpolation. The other processes shown in FIG. 3G are executed by a method similar to the method for the case of the pixel number ratio of red (R), green (G) and blue (B) of 1:2:1.

An image may be formed by three primary colors R/G/B, Y/Cr/Cb signals or both.

In order to maintain a white balance, color filters of all three primary colors R/G/B are used.

As compared to the solid state imaging unit having the color filter layout of FIG. 3E or 3F, the solid state imaging unit having the color filter layout of FIG. 2A or 2B can obtain a proper image without any practical problem although the resolution of green (G) color components is reduced.

Although the pixel number ratio of red (R) is set to 50% for the layouts shown in FIGS. 2A and 2B, the pixel number ratio of red (R) may be increased to photograph the interior of a living body having a large amount of red (R) color components. An endoscope having the solid state imaging unit with a red pixel number ratio larger than 50% may be realized. The number of pixels with red (R) color filters is set larger than the number of pixels with green (G) color filters and the number of pixels with blue (B) color filters to increase the resolution of red (R) color components. With this arrangement, a good quality image of a part containing large red color components can be photographed.

The position of the color filter layer is not limited to that shown in FIG. 3D if only the color filter layer is disposed above the photoelectric conversion elements.

As compared to the solid state imaging unit whose photoelectric conversion elements are disposed in the square matrix shape, the solid state imaging unit whose photoelectric conversion elements are disposed in the honeycomb layout has a larger light reception area per pixel, and color data is obtained not only at each pixel position but also at the intermediate positions of adjacent pixels so that a high resolution can be obtained and a more detailed image can be obtained with the same chip size. It is expected that the solid state imaging unit of the honeycomb layout is suitable for use with an endoscope for observing the interior of a living body.

The present invention has been described in connection with the preferred embodiments. The invention is not limited only to the above embodiments. It will be apparent to those skilled in the art that other various modifications, improvements, combinations, and the like can be made.

The embodiments are suitable for use with a medical endoscope.

1. An endoscope comprising:
a light source for emitting light;
a solid state imaging unit comprising a plurality of photoelectric conversion elements for accumulating signal charges corresponding to an incidence light amount, transfer units for transferring signal charges accumulated in said photoelectric conversion elements, and a plurality of color filters formed above said photoelectric conversion elements; and
a transmission tube accommodating said light source and said solid state imaging unit,
wherein said color filters include red, green and blue color filters, and the number of red photoelectric conversion elements upon which light transmitted through said red color filters are incident is larger than the number of green photoelectric conversion elements upon which light transmitted through said green color filters are incident and the number of blue photoelectric conversion elements upon which light transmitted through said blue color filters are incident.

2. The endoscope according to claim 1, wherein:
said plurality of photoelectric conversion elements of said solid state imaging unit are disposed in a square matrix shape;
said red photoelectric conversion elements are disposed in a checkered pattern, and a row having said red photoelectric conversion elements and said green photoelectric conversion elements disposed alternately and a row having said red photoelectric conversion elements and said blue photoelectric conversion elements disposed alternately are alternately disposed along a column direction.

3. The endoscope according to claim 1, wherein:
said plurality of photoelectric conversion elements of said solid state imaging unit are disposed in a square matrix shape shifted by a half pitch in row and column directions;
said green photoelectric conversion elements and said blue photoelectric conversion elements are disposed in a checkered pattern and in a first square matrix shape; and
said red photoelectric conversion elements are disposed in a second square matrix shape at positions between lattice points of said first square matrix shape.

4. The endoscope according to claim 1, wherein said light source emits white light with light in an infrared range being cut.

5. The endoscope according to claim 1, further comprising a jetting device equipped in said transmission tube, said jetting device jetting out gas or liquid.

6. The endoscope according to claim 1, further comprising a manipulation device equipped in said transmission tube, said manipulation device being capable of holding a target member.
